(19) United States
(12) Patent Application Publication
(10) Pub. No.: US 2023/0405715 A1
(43) Pub. Date: Dec. 21, 2023

(54) METHOD FOR CUTTING ELECTROMAGNETIC STEEL SHEET, AND METHOD FOR FABRICATING CORE

(71) Applicant: SHT Corporation, Izumisano-shi, Osaka (JP)

(72) Inventors: Kazuhiro KASATANI, Izumisano-shi, Osaka (JP); Yuichi IMAZATO, Izumisano-shi, Osaka (JP); Kazusa MORI, Izumisano-shi, Osaka (JP)

(73) Assignee: SHT Corporation, Izumisano-shi, Osaka (JP)

(21) Appl. No.: 18/038,078

(22) PCT Filed: Nov. 17, 2021
(86) PCT No.: PCT/JP2021/042174

§ 371 Date: May 22, 2023

(30) Foreign Application Priority Data
Nov. 25, 2020 (JP) 2020-194802
Nov. 15, 2021 (JP) 2021-185874

(51) Int. Cl. B23K 26/14; B23K 26/38; B23K 26/40

(52) U.S. Cl. CPC B23K 26/14; B23K 2103/04; B23K 26/40; B23K 26/38

(57) ABSTRACT

The present invention provides a method for cutting an electromagnetic steel with a fiber laser, a method for producing an electromagnetic steel component wherein deterioration of magnetic properties is minimized and a rust-preventive effect is endowed, and a method for fabricating a core from the electromagnetic steel component cut by the fiber laser wherein an occurrence of varnish pool is suppressed. According to the present invention, an electromagnetic steel component is obtained by irradiating and cutting the electromagnetic steel sheet with a fiber laser while spraying an assist gas comprising an oxygen concentration of at least 50 volume percent, wherein the electromagnetic steel component is formed with an oxide film for preventing the occurrence of rust and minimizing degradation of magnetic properties to be caused by the heat of the fiber laser. The degraded magnetic properties of the electromagnetic steel component can be restored by the subsequent annealing treatment.

### TECHNICAL FIELD

The present invention relates to a method for producing an electromagnetic steel component used in cores for current transformers, current sensors for vehicles, etc. More specifically, the present invention relates to a method for cutting electromagnetic steel sheet with a fiber laser, a method for producing an electromagnetic steel component having a rust-preventive effect with minimized deterioration of magnetic properties, and a method for fabricating a core using the electromagnetic steel component cut from the electromagnetic steel sheet.

### BACKGROUND ART

Cores used for current transformers and current sensors are made by winding an electromagnetic steel component or element in a strip form obtained by cutting an electromagnetic steel sheet material or by stacking electromagnetic steel components or elements in a chip form obtained by punching out an electromagnetic steel sheet material via a punching press (hereinafter, the terms “winding” and “stacking” are collectively referred to as “stacking”). To produce the core, the electromagnetic steel components are stacked into a core assembly which is then subjected to an annealing treatment and impregnated with varnish (impregnating adhesive) to adhere the electromagnetic steel components to each other.

A slitter device is used to cut an electromagnetic steel sheet into a strip form. For example, Patent Document 1 discloses cutting an elongated electromagnetic steel sheet with a pair of upper and lower rotary blades provided in a slitter device to obtain an electromagnetic steel component in a strip form.

For the cutting by the rotary blade, however, it is difficult to cut curved lines or complicated outer edge lines on the steel sheet. In addition, the rotary blade wears out quickly. Furthermore, the electromagnetic steel sheet may run away against the rotating blade during cutting, making it difficult to obtain an electromagnetic steel component with a narrow width. In addition, the rotary blade is several millimeters thick, causing a decrease in the material yield during cutting.

The rotary blade cutting is to cut the steel sheet with a pair of rotary blades offset on the top and bottom. In this case, burrs 22 are made on the electromagnetic steel component 20 at portions cut out by the blade, as shown in cut plane 21 in FIGS. 8 and 10, causing variation in the width of the cut components. As a result, the core assembly 23a comprising a layer stack of a plurality of electromagnetic steel components 20 will have stepped differences of about ±0.1 mm on the lateral side of the layer stack.

The electromagnetic steel component prepared by the punching press also has burrs on the portion punched out by the press, so the width of the punched components varies. As a result, the core assembly 23a comprising a layer stack of a plurality of electromagnetic steel components 20 have stepped differences on the lateral side of the layer stack, like the above.

Such stepped differences in the core assembly contribute to dimensional defects, poor performance, etc., of the core as the final product.

To produce the core 23, the core assembly 23a in the form of a layer stack of electromagnetic steel components is subjected to an annealing process and then to an impregnation treatment with varnish 25 to adhere to the stacked electromagnetic steel components, thus preventing them from peeling off from each other. If the varnish 25 remains on the lateral side of the core 23, it cures to form a varnish pool 24, as shown in FIG. 10. The varnish pool 24 may sometimes be 0.3 mm or more in diameter and a few tenths of a millimeter in height, so the core 23 with such a varnish pool 24 involves a poor appearance and dimensional errors.

The inventors noticed that cores prepared from the electromagnetic steel components obtained by the rotary blade cutting or press punching are prone to forming a pool of impregnation material. Having conducted intensive research, the inventors found that the following causes develop deposition of impregnation material.

The cause is in the surface structure of a cut face of the electromagnetic steel component 20. For the rotary blade cutting or press punching, the cut face 21 of the electromagnetic steel component 20 is a flat surface with few irregularities and is highly wettable. Hence, the varnish 26 is likely to adhere to the cut face 21, as schematically shown in FIG. 11. The varnish 26 attached to the cut face 21 then cures and produces a varnish pool 24 in a portion of the electromagnetic steel components, as shown in FIG. 10.

Burrs 22 formed on the electromagnetic steel components 20 develop stepped differences (misalignment in the layer stack) on the lateral side of the core. Such stepped differences are also one of the factors contributing to the varnish pool because varnish tends to gather on such portions of stepped differences.

As such, the inventors looked into adopting a method of cutting electromagnetic steel sheets using a laser instead of a rotary blade or a punching press.

For example, Patent Document 2 discloses a method of cutting a galvanized steel sheet using a YAG laser and a CO₂ laser. These lasers irradiate the steel sheet while spraying an assist gas consisting of 2 to 20 volume percent oxygen and the balance nitrogen.

PRIOR ART DOCUMENT (S)

PATENT DOCUMENTS Patent Document 1: Japanese Patent Application Publication HEI 5-299277

Patent Document 2: Japanese Patent Application Publication 2001-353588

### SUMMARY OF THE INVENTION

### Problems to be Solved by the Invention

However, when electromagnetic steel sheets are cut using YAG and CO₂ lasers, the face to be cut is subjected to excessive heat during cutting. As a result, the electromagnetic steel sheet is heated at about 1,500° C. or higher to a depth of about 1,000 μm from the surface of the cut face, thus thermally changing the crystal structure of the electromagnetic steel to impair magnetic properties. In addition, when an assist gas comprising oxygen is used for YAG and CO₂ lasers, black rust develops on the cut face of the electromagnetic steel sheet. The magnetic properties deteriorated by the changed crystal structure and the developed black rust cannot be restored, even if the electromagnetic steel sheet is annealed or otherwise treated. For this reason, the electromagnetic steel components cut with YAG or CO₂ lasers may be used for cores of motors, etc., which are less susceptible to the width of the magnetic hysteresis curve (B-H curve) but could not be used for cores of the products such as current transformers, current sensors, etc., which are subject to the influence of coercivity and residual flux density that require soft magnetic properties over the entire saturation magnetization area from the micro magnetization region of the B-H curve.

The object of the present invention is to provide a method for cutting an electromagnetic steel sheet with a fiber laser, a method for producing an electromagnetic steel component having a rust-preventive effect while minimizing degradation of magnetic properties, and a method for producing a core from the cut electromagnetic steel component while preventing the development of a varnish pool. cl Means to Solve the Problems

According to the present invention, a method for cutting an electromagnetic steel sheet comprises cutting the electromagnetic steel sheet with a fiber laser by irradiating the electromagnetic steel sheet while spraying an assist gas with an oxygen concentration of at least 50 volume percent to obtain an electromagnetic steel component with a cut face having a rust-preventive effect.

The fiber laser is configured to irradiate the electromagnetic steel sheet under conditions wherein a fiber core diameter is 1 μm to 25 μm, the laser output is 300 W to 1000 W, and a cutting speed is 300 mm/sec to 500 mm/sec.

The assist gas comprises an oxygen of at least 60 volume percent and the remainder nitrogen.

According to the present invention, a method for producing an electromagnetic steel component comprises subjecting the electromagnetic steel component cut by the above-mentioned method for cutting the electromagnetic steel sheet to an annealing treatment, thereby restoring magnetic properties.

The annealing treatment is preferably performed under heating conditions at 750° C. to 850° C. for at least one hour.

According to the present invention, a method for fabricating a core comprises:

a step of winding or stacking the electromagnetic steel component cut by the above-mentioned method for cutting the electromagnetic steel sheet to obtain a core assembly,

a step of subjecting the core assembly to an annealing treatment to restore magnetic properties of the electromagnetic steel component; and

soaking the core assembly in a varnish.

The annealing treatment is preferably performed under heating conditions at 750° C. to 850° C. for at least one hour.

The varnish can be a material containing an acrylic monomer and an epoxy resin.

### Effects of the Invention

According to the present invention, a method for cutting an electromagnetic steel sheet is to cut the electromagnetic steel sheet by irradiating it with a fiber laser while spraying an assist gas having a high oxygen concentration, thereby obtaining an electromagnetic steel component. The fiber laser can concentrate its energy on a small area of the electromagnetic steel sheet. Therefore, the electromagnetic steel sheet can be cut out without being excessively heated on the face to be cut. The resulting electromagnetic steel component exhibits only minimal change in the crystal structure on the layer of the cut face and only minimal degradation of magnetic properties. In addition, the assist gas with high oxygen concentration oxidizes the cut face at high speed to form an oxide film. The oxide film is effective in inhibiting the formation of red rust. Therefore, the electromagnetic steel component obtained via the present cutting method does not need to be treated with rust-preventive treatment or wrapped with rust-preventive paper.

Electromagnetic steel components cut by the fiber laser have uniformly cut faces and are free from burrs that occur when cut with a rotary blade or punched out with a punching press. Therefore, the wound or stacked core assembly has the aligned surface of the cut faces, so that no stepped differences can be formed on the lateral side of the core assembly.

The wound or stacked core assembly is subjected to an annealing treatment. For the electromagnetic steel components cut by a fiber laser, the area where the crystalline structure changed on the cut face is very shallow. Therefore, the crystal structure of the surface of the cut face can be restored by the subsequent annealing treatment, whereby the magnetic properties of the electromagnetic steel component can be recovered.

After the magnetic properties are restored, the core assembly is soaked in varnish and then dried. Since the cut face of the electromagnetic steel component has fine irregularities, the wettability of the core assembly is low due to the lotus effect. In addition, the core assembly is free of stepped differences on the lateral side thereof. Therefore, the occurrence of a varnish pool is decreased, and the appearance and dimensional defects of the resulting cores are also lessened.

The cores made by the present invention can be suitably used as punched cores for current transformers and cores for current sensors in vehicles.

### BRIEF DESCRIPTION OF THE DRAWINGS

FIGS. 1 (a) and (b) are photographs of the cut face of an electromagnetic steel component obtained by the cutting method of the present invention, wherein (b) is an enlarged view of (a).

FIG. 2 is an enlarged schematic diagram showing a comparison of the cuttings of a fiber laser and a rotary blade before and after annealing treatment, with respect to the metallic structure of the cut face.

FIG. 3 shows a cross-sectional view of the core assembly.

FIGS. 4 (a), (b), and (c) are photographs of the lateral side of the core assembly after annealing treatment, wherein (a) shows the cutting by a fiber laser, and (b) and (c) show the cutting by a rotary blade.

FIGS. 5 (a) and (b) are photographs of B-H curves of the electromagnetic steel components before and after annealing treatment wherein (a) shows the cutting by a fiber laser, and (b) shows the cutting by a rotary blade.

FIG. 6 is an enlarged photograph showing the state of a varnish pool in the core of the present invention.

FIG. 7 is a cross-sectional view illustrating the mechanism that prevents the occurrence of a varnish pool in the core of the present invention.

FIG. 8 is an enlarged photograph of the cut face of the electromagnetic steel component cut by the rotary blade.

FIG. 9 is a cross-sectional view of a core assembly consisting of stacked electromagnetic steel components cut by the rotary blade.

FIG. 10 is an enlarged photograph showing the varnish pool occurred on the core comprising the stacked electromagnetic steel components cut by the rotary blade.

FIG. 11 is a cross-sectional view illustrating the mechanism wherein the varnish pool occurs on the core comprising the stacked electromagnetic steel components cut by the rotary blade.

### MODE FOR CARRYING OUT THE INVENTION

One embodiment of the present invention for a method of cutting electromagnetic steel sheets and a method of making cores will be described below.

The electromagnetic steel sheets to be cut may be oriented or non-oriented electromagnetic steel sheets. The thickness of the electromagnetic steel sheet is preferably 0.2 mm to 0.5 mm. Of course, the thickness of the electromagnetic steel sheet is not limited to it.

The fiber laser used for cutting electromagnetic steel sheets in the present invention is a laser that is supplied from the fiber laser machine to a laser unit through an optical fiber and is emitted from a laser head of the laser unit. The laser unit is equipped around the laser head with an air nozzle for spraying an assist gas. The assist gas is supplied from a gas cylinder under high pressure to the air nozzle. Then, the air nozzle sprays the high-pressure assist gas toward the cutting position while the fiber laser cuts the electromagnetic steel sheet.

The fiber laser may have a fiber core diameter of 1 μm to 25 μm, and can output 300 W to 1000 W, although it is not limited to these values.

For example, a fiber laser can irradiate an electromagnetic steel sheet to provide a spot diameter of 10 μm to 25 μm.

Assist gas with a relatively high oxygen concentration is used. For example, an oxygen concentration of 50 volume percent or larger, preferably 60 volume percent or larger, may be used as the assist gas. The remainder may be substantially nitrogen. The purpose of using the assist gas with a high oxygen concentration is to ensure that the cut face of the electromagnetic steel sheet is appropriately oxidized. The flow rate of assist gas is preferably 30 liters/min. to 100 liters/min., although not limited to them.

The feed rate of the electromagnetic steel sheet is preferably adjusted to conform to the cutting speed of 300 mm/sec to 500 mm/sec. The feed rate is also adjustable depending on the thickness of the electromagnetic steel sheet, the fiber core diameter, and the laser output.

A fiber laser irradiates an electromagnetic steel sheet and cuts it to obtain an electromagnetic steel component. The fiber laser makes it possible to cut curved lines or complex outer edge shapes that cannot be achieved with a rotating blade. In addition, the fiber laser does not require a die, while the press punching requires a die for each shape of the electromagnetic steel sheet.

According to the present invention, a high-oxygen assist gas is sprayed from the fiber laser to the electromagnetic steel sheet at the position to be cut, so that the cut face is rapidly oxidized by reaction with oxygen. Although the cut face generates dross such as molten metal, the assist gas blows away any dross generated, so the cut surface is cleaned up.

As mentioned above, the fiber laser cuts the electromagnetic steel sheet while spraying a high-oxygen assist gas. The resulting electromagnetic steel component is formed on the cut face with an oxide film. The oxide film has the effect of preventing the formation of red rust that affects magnetic properties and other characteristics. In contrast, the electromagnetic steel sheet cut with a blade or punched with a press does not form an oxide film on the cut surface but instead develops red rust. Such red rust necessitates wrapping the cut face with rust-preventive paper, etc. The electromagnetic steel sheet cut with the fiber laser does not need such wrapping work since the oxide film formed on the cut face prevents such red rust from being formed.

When an electromagnetic steel sheet is cut with a fiber laser, the cut face of the sheet is instantaneously heated to a high temperature (e.g., 1500° C. or higher), which changes the crystal structure of a surface layer of the cut face. In this regard, the fiber laser concentrates energy on a small area, limiting changes in the crystal structure to a surface layer depth of approximately 10 μm to 50 μm. This depth is in a very shallow range compared to YAG and CO₂ lasers that change the crystal structure to a surface layer depth of about 1000 μm or more, thus minimizing degradation of magnetic properties. The inventors have found that if the change of crystal structure on the electromagnetic steel sheet after cutting is very shallow in depth, the crystal structure can be recovered and the magnetic properties can be restored by applying an annealing treatment to the changed crystal structure. The annealing treatment is described later.

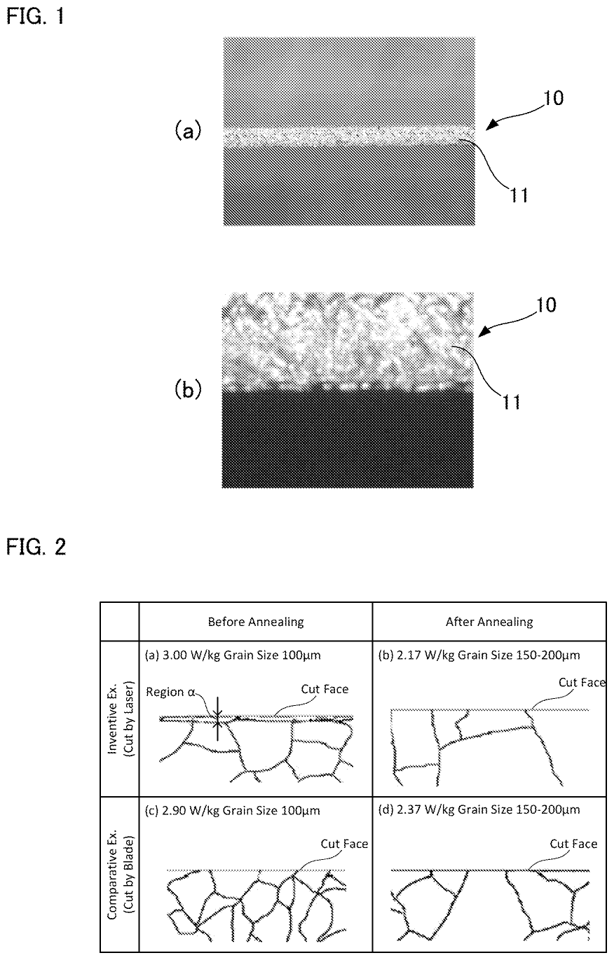

FIGS. 1 (a) and (b) are photographs of the cut face 11 of an electromagnetic steel component 10 obtained by the cutting method of the present invention, wherein (b) is an enlarged view of (a). FIG. 1 shows that the cut face 11 obtained by the fiber laser has many fine irregularities. When the electromagnetic steel sheet is cut with the fiber laser, there are formed fine and nearly dome-like irregularities of several tens of micrometers in height and diameter on the surface of the cut face at a pitch of several tens of micrometers, and no dross remains on the cut face. Dross may remain on the cut face due to insufficient output and/or slower cutting speed, etc., of the fiber laser. Referring to FIGS. 1 (a) and (b), the cut face 11 is shiny, which indicates that a colorless oxide film (several micrometers thick, as described later) is formed on the surface.

FIGS. 2 (a) and (c) are schematic diagrams of the metallic structure of the cut face of the electromagnetic steel sheet after cutting and before annealing treatment. FIG. 2 (a) shows the cut face of the electromagnetic steel sheet cut by a fiber laser, and FIG. 2 (c) shows the cut face of the electromagnetic steel sheet cut by a rotary blade.

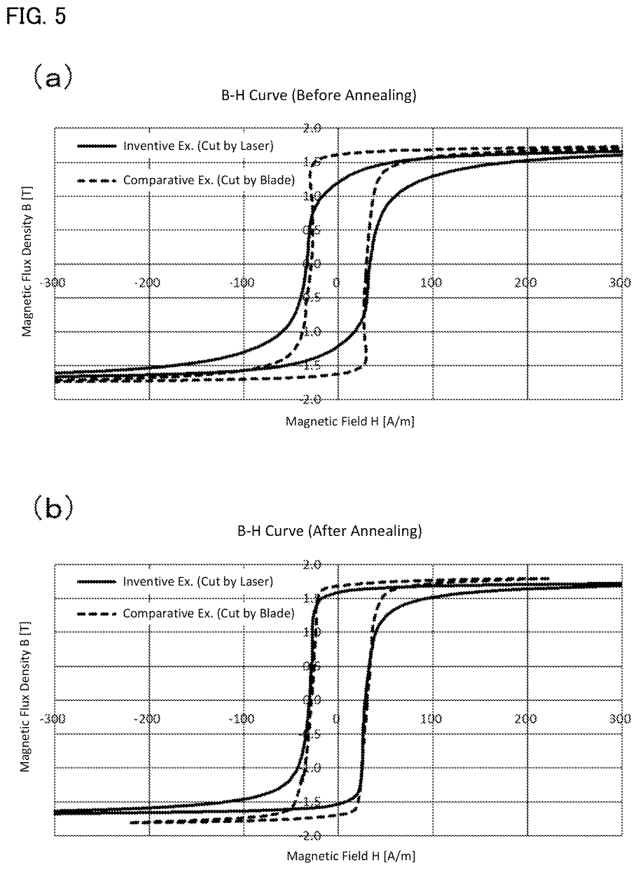

FIG. 2 (a) shows that the crystal structure of the electromagnetic steel sheet cut with the fiber laser is metamorphosed by the heat of the fiber laser in a very shallow region (indicated by sign α) of the surface. On the other hand, FIG. 2 (c) shows that any heat-induced metamorphosis or change cannot be found in the crystal structure of the surface of the electromagnetic steel sheet cut by the rotary blade. Referring to the B-H curve in FIG. 5 (a), the cut face by the fiber laser (shown as a solid line) is smaller than the cut face by the rotary blade (shown as a dotted line) in terms of residual magnetic flux density, indicating that the magnetic properties were decreased due to the change in the crystal structure. However, the subsequent annealing treatment can restore the reduced magnetic property, as described later.

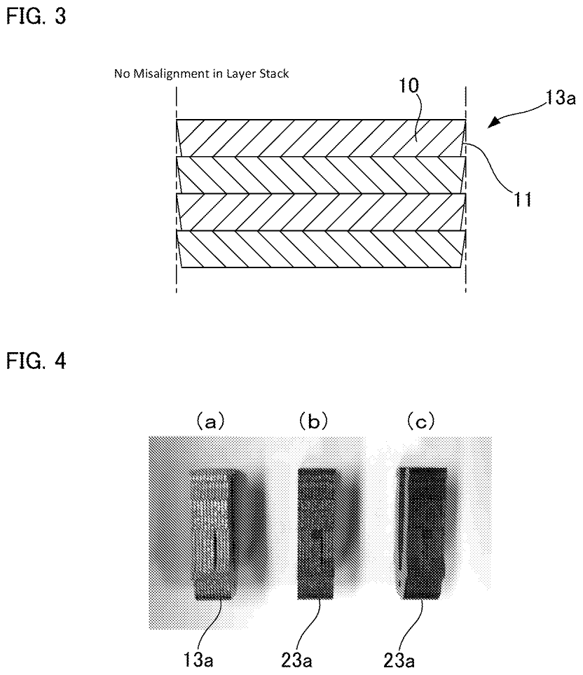

FIG. 3 is a cross-sectional view of a core assembly 13a prepared by cutting an electromagnetic steel sheet to the same shaped components 10 via a fiber laser and stacking a plurality of the components 10 of electromagnetic steel. The electromagnetic steel sheet is cut by a laser beam with a diameter reduced into a conical shape. Hence, the cut face 11 of the electromagnetic steel component 10 is slightly slanted, as illustrated. Still, the lateral side of the layer stack of the electromagnetic steel components 10 is in alignment, and there is not found misalignment in the layer stack. In FIG. 3, the inclination of the cut face 11 is shown exaggeratedly, but the actual angle of inclination is approximately 1 degree or less. When the electromagnetic steel sheet is cut with a fiber laser, the electromagnetic steel component 10 can be controlled to a high precision (approximately ±0.05 mm or less) in terms of the variation in the shape of the cut face 11 and the width.

FIG. 3 shows a core assembly 13a with the cut electromagnetic steel components 10 stacked on top of each other, and the core assembly is subjected to an annealing treatment. The annealing treatment is performed at 750° C. to 850° C. for at least 1 hour. The annealing treatment is preferably performed at 780° C. to 820° C. for at least 2 hours. The atmosphere during annealing can be an inert gas atmosphere.

When the electromagnetic steel sheet cut by the fiber laser is subjected to an annealing treatment, the region α (shown in FIG. 2 (a)) where the crystal structure changed restores the damaged crystal structure, and in its deeper part, the grain size of the crystal structure increases, as shown in FIG. 2 (b). As a result, the residual magnetic flux density increases, and the magnetic properties can be restored, as shown in FIG. 5 (b).

FIG. 4 (a) is a photograph of the lateral side of the present core assembly 13a prepared from the electromagnetic steel components cut with a fiber laser and subjected to the annealing treatment. FIGS. 4 (b) and (c) are photographs of the lateral side of the comparative core assembly 23a prepared from the electromagnetic steel components cut with a rotary blade and subjected to the annealing treatment. When the annealing is applied to the core assemblies 13a and 23a, a thin oxide film with a thickness of several hundred nanometers is formed on the lateral side surface of the core assembly regardless of the cutting method. However, as shown in FIG. 4 (a), the core assembly 13a of the present invention does not result in an appearance of any temper color (interference color of light) caused by the formation of the thin oxide film after the annealing treatment. On the other hand, the temper color is seen in the core assembly 23a prepared from the electromagnetic steel components cut by the rotary blade, as shown in FIGS. 4 (b) and (c).

This difference is attributed to the fact that the fiber laser produces a colorless oxide film with a thickness of several micrometers on the cut face 11 during cutting. When the colorless oxide film is formed in advance before the annealing process, no temper color appears even if a thin oxide film of several hundred nanometers thick is formed on top of it during the annealing process. On the other hand, no such oxide film is produced on the cut face 21 of the electromagnetic steel component 20 cut by the rotary blade, so a thin oxide film of several hundred nanometers thick is formed directly on the cut face 21 during the annealing treatment, resulting in a temper color. Temper-colored cores 23 generally result in a poor appearance.

After the annealing process, the core assembly is immersed in a varnish. The varnish is an impregnating adhesive, for example, a liquid containing acrylic monomers and epoxy resins of relatively low viscosity that is easy to permeate between the layer stack of the electromagnetic steel components.

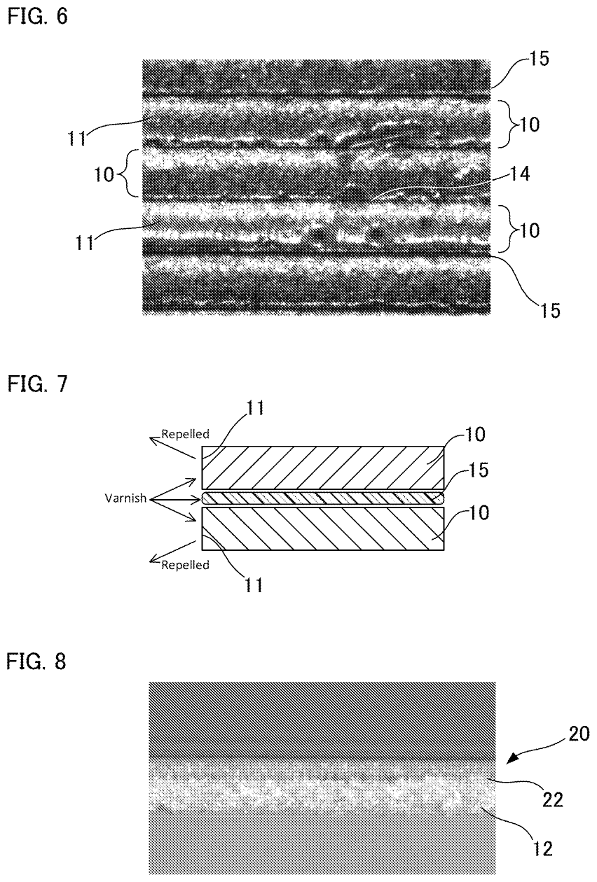

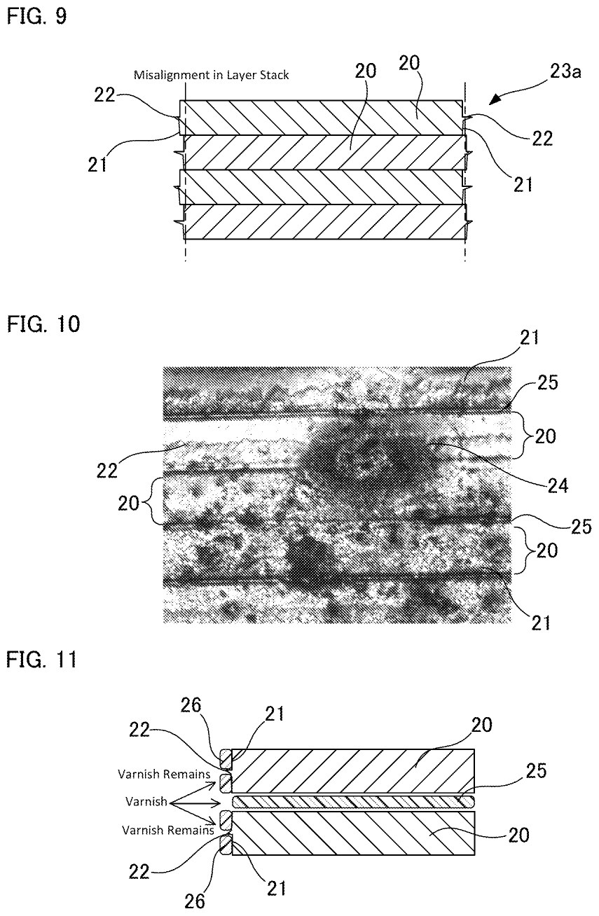

When the core assembly is immersed in a liquid varnish, the varnish enters between the layer stack (including the wound layer) of the electromagnetic steel components and cures to adhere the electromagnetic steel components to each other to produce the core. To facilitate impregnation of the varnish between the electromagnetic steel components, the core assembly is preferably preheated to about 80° C. to 90° C. and then immersed in the varnish under the condition of ambient temperature and atmospheric pressure. This ensures that the varnish can effectively enter between the electromagnetic steel components by capillary action during the cooling process of the preheated electromagnetic steel components. After the core assembly is immersed in the varnish, the air is blown to drop off the varnish attached to the lateral sides and other parts of the core assembly. The core assembly is then held in an oven at approximately 110° C. to 150° C. for 2 to 3 hours to dry the varnish whereby a core 13 is produced. FIG. 6 shows that the core 13 has almost no varnish pool 14. The droplet appearing like a varnish pool 14 is a varnish repelled on the cut face 11 and is in the form of a rounded shape. This varnish pool is only about 0.05 mm in diameter and about 0.02 mm in height, which is less than one-tenth of the thickness of the electromagnetic steel component. Therefore, no practical hindrance is raised in its appearance and dimensions.

The reasons why the core of the invention is less likely to form varnish pools are explained below. As described above, the cut face 11 of the electromagnetic steel component 10 cut by the fiber laser has many fine, nearly dome-shaped irregularities of several tens of micrometers in height and diameter at intervals of several tens of micrometers pitch (shown in FIG. 1). The core assembly is then formed by stacking the electromagnetic steel components having these cut faces. The many microscopic irregularities on the cut face 11 decrease wettability due to the lotus effect, thus preventing the liquid varnish from adhering to the cut faces 11. Therefore, as shown in FIG. 7, the varnish remains between the electromagnetic steel components 10, 10 as indicated by sign 15, and the varnish adhered to the cut surface 11 is repelled from the cut surface 11. Hence, the varnish does not deposit on the lateral sides of the core 13, as shown in FIG. 6. In addition, as shown in FIG. 3, the electromagnetic steel components 10 are produced using the electromagnetic steel sheets cut with high dimensional accuracy, so that the lateral sides of core assembly 13a stacked by the components 10 are free of any stepped differences. As a result, the amount of varnish that gathers on the sides of core 13 can be decreased and the occurrence of varnish pool can be reduced.

The fiber laser cutting of the present invention can achieve curved-line processing that cannot be realized with a rotary blade and also improves the yield of electromagnetic steel components. The cutting of the electromagnetic steel sheet is performed while spraying an assist gas of high oxygen, so an oxide film is formed on the cut face to prevent the formation of red rust. The deterioration of magnetic properties on the surface of the electromagnetic steel component cut by the fiber laser is minimized, and the annealing treatment can restore the degraded magnetic properties. In addition, the cut face of the electromagnetic steel component has a lot of fine irregularities. Hence, the varnish is less likely to adhere to the cut faces due to the lotus effect, thus decreasing the occurrence of the varnish pool in the core. The core prepared from the electromagnetic steel components of the present invention has excellent magnetic properties with few defects of appearance and dimension and is therefore suitable for use as various cores such as power transformers, choke coils, reactors, current transformers, current sensors for vehicles, and others.

The cutting method of the present invention inhibits red rust from forming on the surface of the electromagnetic steel component, as described above. So, the electromagnetic steel components cut by the present invention can be stocked until the period of use for making cores, etc., later, and can be stacked and subjected to annealing and impregnation treatments to produce the core, as may be necessary.

The above description is for the purpose of explaining the invention and should not be interpreted as limiting or reducing the scope of the invention described in the claims. Also, it is not limited to the above embodiment, but various variations of the configuration of each part of the invention are of course possible within the technical scope of the claims.

During the process of cutting electromagnetic steel sheets, it is also possible to cut the electromagnetic steel sheet in combination with the cutting methods, for example, by blade cutting for straight sections and fiber laser cutting for curved sections.

### EXAMPLES

### Example 1

An electromagnetic steel sheet was cut with a fiber laser and a rotary blade, and the cut face was observed before and after annealing treatment, and the B-H curve was measured.

The electromagnetic steel sheet is a directional electromagnetic steel sheet with a thickness of 0.23 mm and was cut by a fiber laser under the following conditions: fiber core diameter 14 μm; laser output 400 W; cutting speed 500 mm/sec; oxygen concentration of assist gas 100 volume percent; and flow rate 30 liters/min. (inventive example). For comparison, a directional electromagnetic steel sheet of the same thickness was cut by a rotary blade (comparative example).

Schematic diagrams of the metallic structure of the cut face of the inventive example (fiber laser cut) and the cut face of the comparative example (rotary blade cut) before the annealing treatment are shown in FIG. 2 (a) and FIG. 2 (c), respectively. FIG. 2 (a) shows that the cut face of the inventive example was metamorphosed by the heat of the fiber laser in the region α, and the crystal structure changed. On the other hand, FIG. 2 (c) shows that the cut face of the comparative example had no change in the metamorphism or crystalline structure. FIG. 5 (a) shows the measurement result of the B-H curve for the electromagnetic steel sheet wherein the saturation magnetic flux density of the inventive example (solid line) is smaller than that of the comparative example (dotted line), indicating that the magnetic properties decreased. The iron losses of the inventive and comparative examples were 2.90 W/kg and 3.00 W/kg, respectively. The average grain size of the crystal structure of both examples was 100 μm.

Next, the electromagnetic steel sheets of the inventive and comparative examples were subjected to the annealing treatment at 800° C. for 2 hours. The result of the inventive example is shown in FIG. 2 (b) wherein the region a disappeared. In addition, as shown in FIG. 2 (b) and FIG. 2 (d), the average grain size of the crystals in both the inventive and comparative examples increased up to 150 to 200 μm. As for the iron loss, the inventive example was 2.37 W/kg, and the comparative example was 2.17 W/kg, which provided an improvement compared to those before the annealing treatment.

FIG. 5 (b) shows the measurement results of the B-H curves for the inventive and comparative examples after annealing, wherein the saturation magnetic flux density of the inventive example (solid line) is almost the same as that of the comparative example (dotted line), indicating that the magnetic properties were restored to the level of the comparative example by the annealing treatment.

Thus, according to the inventive example, the electromagnetic steel sheet is cut with a fiber laser while spraying an assist gas with a high oxygen concentration and then subjected to the annealing treatment, providing magnetic properties equivalent to those obtained by cutting with a rotary blade. In addition, the fiber laser can easily cut not only straight lines but also curved lines. Therefore, cores with a circular cross-section can be obtained while turning the fiber laser. In rotary blade cutting, the rotary blade wears out, so the worker must watch the blade edge to prevent cutting defects caused by wear. In this regard, the fiber laser has no relation to wear-and-tear issues and does not need such watching work. Further, during the rotary blade cutting, the electromagnetic steel sheet may run away against the rotating blade. On the other hand, the fiber laser cutting has no such phenomena and therefore improves yield.

### Example 2

In this example, the cutting of electromagnetic steel sheets with a fiber laser was conducted by changing irradiation conditions and oxygen concentration of the assist gas to observe the development of red rust in a high-temperature, high-humidity atmosphere.

Test specimens were prepared using a directional electromagnetic steel sheet with a thickness of 0.23 mm. The cutting conditions of the electromagnetic steel sheet are as follows: fiber core diameter 14 μm; laser output 400 W; cutting speeds 300 mm/sec and 500 mm/sec; oxygen concentration of assist gas is 100 volume percent, 70 volume percent, and 50 volume percent for the inventive examples, and 40 volume percent for the reference example; and flow rate 30 liters/min. For comparison, a directional electromagnetic steel sheet of the same thickness was cut by a rotary blade (comparative example). After cutting, all of the test specimens were annealed at 800° C. for 2 hours.

Each specimen was placed in high-temperature and high-humidity environments at a temperature of 85° C. and a humidity of 85% until red rust was observed on the cut face of the specimen. Number of days until red rust was observed for each specimen is shown in Table 1.

TABLE 1

| | Cutting by Fiber Laser (Inventive Example) | | Cutting by |
|---|---|---|---|
| Oxygen | Cutting | Cutting | Rotary Blade |
| Concen- | Speed | Speed | (Compar- |
| tration | (300 | (500 | ative |
| (vol %) | mm/s) | mm/sec) | Ex.) |
| 100 | 4 weeks | 4 weeks | 1 day |
| | (28 days) | (28 days) | |
| 70 | 4 weeks | 4 weeks | |
| | (28 days) | (28 days) | |
| 50 | 3 weeks | 3 weeks | |
| | (21 days) | (21 days) | |
| 40 | 1 day | 1 day | |
| Reference | | | |
| Ex.) | | | |

Table 1 shows that in all the inventive examples wherein the fiber laser cutting was performed in an assist gas atmosphere with an oxygen concentration of at least 50 volume percent, the cut face was free of red rust for more than 3 (three) weeks or longer. In more detail, the inventive examples cut under an assist gas atmosphere with an oxygen concentration of at least 70 volume percent did not develop red rust for four (4) weeks. On the other hand, the reference example wherein the oxygen concentration of the assist gas is 40 volume percent and the comparative example of the rotary blade cutting showed that red rust already appeared on the cut face only one day.

From the above, it can be seen that when the fiber laser cutting is performed in an assist gas atmosphere with an oxygen concentration of 50 volume percent or more, an oxide film is formed on the cut face of the electromagnetic steel sheet, and that the oxide film acts to suppress the formation of red rust. The electromagnetic steel component of the inventive examples prevents forming of red rust even if left in an oxidizing atmosphere for an extended period, so rust-proofing or packaging with rust-preventive paper is not required. This feature is advantageous, especially when the electromagnetic steel components are stored in the hoop state because they become large size and bulky. It is preferable to use an assist gas with an oxygen concentration of at least 60 volume percent to ensure the formation of an oxide film on the cut face.

### Example 3

Current transformers were fabricated from E-shaped cores made by stacking E-shaped components cut along the entire circumference by a fiber laser and E-shaped cores made by stacking E-shaped components punched out into the same shape by a press machine. Then the output voltage characteristics of the transformers were measured before and after the annealing treatment.

An E-shaped core of the inventive example was prepared using a non-directional electromagnetic steel sheet with a thickness of 0.35 mm. The cutting conditions of the fiber laser for the electromagnetic steel sheet are as follows: fiber core diameter 14 μm; laser output 300 W; cutting speeds 300 mm/sec; oxygen concentration of assist gas is 100 volume percent; and flow rate liters/min. An E-shaped core of the comparative example was also prepared by punching out the non-directional electromagnetic steel sheet of the same thickness via a press machine.

The E-shaped cores of the inventive and comparative examples prepared as per mentioned above were used as an iron core to produce a current transformer with a turn ratio of 1:3000 (“before annealing” in Table 2), and the output voltage characteristics of the transformer were measured. In addition, the E-shaped cores were subjected to the annealing treatment at 800° C. for 2 hours and fabricated into the current transformers (“after annealing” in Table 2). Then, the output voltage characteristics of the transformers were measured. The results are shown in Table 2.

TABLE 2

| | 50 Hz | 60 Hz |
|---|---|---|
| Before Annealing | | |
| Punched-out Core (comparative) | 6.036 V | 6.108 V |
| Laser-cut Core (inventive) | 5.840 V | 5.955 V |
| | (−3.2%) | (−3.2%) |
| After Annealing | | |
| Punched-out Core (comparative) | 6.420 V | 6.448 V |
| Laser-cut Core (inventive) | 6.400 V | 6.428 V |
| | (−0.3%) | (−0.3%) |

Table 2 shows that before the annealing treatment, the output voltage of the inventive example was 3.2% lower than that of the comparative example, but after the annealing treatment, the output voltage improved to a drop of 0.3%. The difference in the output voltage after the annealing treatment is of a commercially acceptable level. In the case where the electromagnetic steel sheet cut by a fiber laser is pressed and punched to prepare E-shaped components with one edge left in a fiber-laser cut state, only one edge is the area to be affected by the heat from the laser cutting, whereby the output voltage difference can be further improved.

### EXPLANATION OF REFERENCE NUMBERS

10 Electromagnetic steel sheet

11 Cut face

13 Core

13a Core assembly

14 Varnish pool

15 Varnish

1-8. (canceled)

9. A method for cutting an electromagnetic steel sheet comprising
cutting the electromagnetic steel sheet with a fiber laser by irradiating the electromagnetic steel sheet while spraying an assist gas with an oxygen concentration of at least volume percent to obtain an electromagnetic steel component with a cut face having a rust-preventive effect.

10. The method according to claim 9 wherein the fiber laser is configured to irradiate the electromagnetic steel sheet under conditions wherein a fiber core diameter is 1 μm to 25 μm, a laser output is 300 W to 1000 W, and a cutting speed is 300 mm/sec to 500 mm/sec.

11. The method according to claim 9 wherein the oxygen concentration is at least 60 volume percent and the remainder nitrogen.

12. The method according to claim 10 wherein the oxygen concentration is at least 60 volume percent and the remainder nitrogen.

13. A method for producing an electromagnetic steel component comprising
subjecting the electromagnetic steel component cut by the method according to claim 9 to an annealing treatment to restore magnetic properties of the electromagnetic steel component.

14. A method for producing an electromagnetic steel component comprising
subjecting the electromagnetic steel component cut by the method according to claim 10 to an annealing treatment to restore magnetic properties of the electromagnetic steel component.

15. The method according to claim 13 wherein the annealing treatment is performed at 750° C. to 850° C. for at least one hour.

16. The method according to claim 14 wherein the annealing treatment is performed at 750° C. to 850° C. for at least one hour.

17. A method for fabricating a core comprising the steps of:
winding or stacking an electromagnetic steel component cut by the method according to claim 9 to obtain a core assembly;
subjecting the core assembly to an annealing treatment to restore magnetic properties of the electromagnetic steel component; and
soaking the core assembly in a varnish.

18. A method for fabricating a core comprising the steps of:
winding or stacking an electromagnetic steel component cut by the method according to claim 10 to obtain a core assembly;
subjecting the core assembly to an annealing treatment to restore magnetic properties of the electromagnetic steel component; and
soaking the core assembly in a varnish.

19. The method according to claim 17 wherein the annealing treatment is performed at 750° C. to 850° C. for at least one hour.

20. The method according to claim 18 wherein the annealing treatment is performed at 750° C. to 850° C. for at least one hour.

21. The method according to claim 17 wherein the varnish is a material containing an acrylic monomer and an epoxy resin.

22. The method according to claim 18 wherein the varnish is a material containing an acrylic monomer and an epoxy resin.

23. The method according to claim 19 wherein the varnish is a material containing an acrylic monomer and an epoxy resin.

24. The method according to claim 20 wherein the varnish is a material containing an acrylic monomer and an epoxy resin.
